(19) United States
(12) Patent Application Publication
(10) Pub. No.: US 2018/0243828 A1
(43) Pub. Date: Aug. 30, 2018

(54) Method and Device for Producing A Three-dimensional Object

(71) Applicant: EOS GmbH Electro Optical Systems, Krailling (DE)

(72) Inventor: Thomas Hoferer, Krailling (DE)

(73) Assignee: EOS GmbH Electro Optical Systems, Krailling (DE)

(21) Appl. No.: 15/758,561

(22) PCT Filed: Sep. 2, 2016
(86) PCT No.: PCT/EP2016/001493

§ 371 Date: Mar. 8, 2018

(30) Foreign Application Priority Data
Sep. 11, 2015 (DE) 10 2015 217 469.7

(51) Int. Cl. B22F 3/105; B29C 64/153; B29C 64/40; B33Y 10/00

(52) U.S. Cl. CPC B22F 3/1055; B29C 64/153; B22F 2003/1058; B33Y 10/00; B29C 64/40

(57) ABSTRACT

Disclosed is a method for producing a three-dimensional object by layer-wise applying and selectively solidifying a building material. The method includes (a) applying a layer of the building material to a build area by means of an application device, (b) selectively solidifying the applied layer at positions that correspond to the cross-section of the object in the respective layer and at positions that correspond to the cross-section of an envelop region and (c) repeating the steps of applying and selectively solidifying until the object and the envelop region are completed. The envelop region encloses the object in at least a section thereof, wherein those positions that correspond to the envelop region are solidified less strongly than those positions that correspond to the three-dimensional object.

The present invention is directed to a method and a device for producing a three-dimensional object by selectively solidifying a building material layer by layer.

Methods and devices of this kind are used, for example, in rapid prototyping, rapid tooling or additive manufacturing. An example of such a method is known as “selective laser sintering or laser melting.” In this method, a thin layer of a building material is repeatedly applied and the building material is selectively solidified in each layer by selective irradiation with a laser beam.

Particularly in the case of metallic building materials, it is advantageous to produce the object on a building platform to which the building material adheres upon its solidification. Such a method is known from DE 195 11 772 C2. The three-dimensional object produced can be separated from the building platform upon completion, or the building platform forms an integral part of the object.

DE 195 38 257 A1 describes a method in which, in addition to producing an object, it is also provided to produce a support structure for supporting parts of the object or of the entire object. In order to provide for easy detachment of the support structure from the object produced, the support structure is partitioned into an inner core region and an outer envelop region, and the envelop region is irradiated less strongly.

Detachment of the support structure is carried out in known methods by means of a suitable tool such as pliers, a saw or a file. This requires a considerable amount of time and skill, in particular with filigree parts or cavities located inside the object that are hardly accessible, and is therefore potentially complex.

It is an object of the present invention to provide an alternative, preferably improved method for producing a three-dimensional object and a device suited to carry out the method, wherein in particular the object to be produced is well supported during the production process and the support structure can be removed from the readily produced object in a simple way.

The object is achieved by a method according to claim 1, a computer program according to claim 12, a control command generation unit according to claim 13, a control unit according to claim 14 and a device according to claim 15. Further developments of the invention are given in the respective dependent claims, wherein the methods can also be further developed by the features of the devices, which features are given below and in the dependent claims, or vice versa.

According to the invention, the method for producing a three-dimensional object by layer-wise applying and selectively solidifying a building material comprises the steps of: applying a layer of the building material to a build area by means of an application device, selectively solidifying the applied layer at positions that correspond to the cross-section of the object in the respective layer and at positions that correspond to the cross-section of an envelop region and repeating the steps of applying and selectively solidifying until the object and the envelop region are completed. In said method, the building material is solidified such that the envelop region encloses the object in at least a section thereof, wherein those positions that correspond to the envelop region are solidified less strongly than those positions that correspond to the three-dimensional object.

As a result, an envelop region is solidified around and along with the object, which envelop region encloses the object in at least a section and thus supports it. This makes it possible to also produce filigree parts and objects having internal cavities. Since the envelop region is solidified less strongly than the three-dimensional object, the completed object can be separated from the envelop region in a simple manner.

Preferably, the envelop region completely encloses the three-dimensional object in at least 2, preferably in all three spatial directions. Enclosing in at least 2 spatial directions can refer to one or to several layers or arbitrarily chosen cross-sections of the object, preferably to all layers or cross-sections. Enclosing in all three spatial directions analogously also means a partial three-dimensional enclosing of the object, preferably completely enclosing the object such that all its outer surfaces directly or indirectly adjoin the envelop region. This allows for uniformly supporting and possibly protecting the object to be produced within all building regions and thus provides for good stability. Furthermore, the envelop region prevents deformation of the object by internal stress and thermal effects.

Preferably, the envelop region encloses the object or the part of the object substantially in a form-fitting manner. This provides for good connection of the object to the envelop region and thus for good stability of the object.

The method according to the invention can further comprise the following step: removing the envelop region after completion of the object. Removing the envelop region is preferably implemented by means of blasting, wherein preferably hard particles are used as blasting medium when blasting, in particular ceramic particles and/or steel balls. By means of blasting, the envelop region can be removed from the object quickly and in an easy way without damaging the object.

If solidification of the building material is implemented by introducing energy by means of radiation, preferably less energy is introduced at those positions that correspond to the envelop region than at the object itself. As a result, the envelop region is solidified less strongly than the three-dimensional object and can thus be easily removed from the object.

Preferably, the envelop region is at least partially solidified at a distance from the three-dimensional object, wherein the distance between the envelop region and the object is larger than or equal to 0.06 mm and/or smaller than or equal to 0.10 mm and further preferably constant. The spacing between the envelop region and the object prevents the envelop region from adhering to the three-dimensional object, which improves the surface quality of the object. The computation of the geometry of the envelop region is simplified by selecting a gap of constant size.

Preferably, the building material is a material in powder form, more preferably a metal powder. Since supporting the object to be produced is particularly important in the case of metallic building materials, it is possible to achieve a particularly good effect by means of the envelop region when using metal powders.

Preferably, the following steps are carried out in advance: computing the geometry of the three-dimensional object, computing the geometry of a body which encloses the object in at least a section thereof, subtracting the geometry of the object from the geometry of the body, saving the generated geometry as the geometry of the envelop region, and computing the cross-section of the object and the cross-section of the envelop region in the respective layers. Thus, the layer information required for the production of the object and the envelop region can be computed in a simple manner.

Preferably, the geometry of the body is chosen such that the body has a volume as small as possible and/or that the body completely encloses the three-dimensional object. By selecting a volume as small as possible—in particular taking into account the region of the object to be enclosed and independently of this preferably depending on a predefined (for example, material- or machine-dependent) minimum dimension of the envelop region—an envelop region as small as possible is determined. The amount of building material required for solidifying the envelop region is thus reduced and the area to be solidified is reduced. This increases the efficiency and profitability of the production process.

A computer program according to the invention can be loaded into a programmable control unit and comprises program code means for carrying out all steps of the method described above when the computer program is executed on the control unit. This makes it possible to carry out the method according to the invention in a simple manner by executing the computer program in a control unit.

According to the invention, a control command generating unit for a device for producing a three-dimensional object by layer-wise applying and selectively solidifying a building material is adapted to generate control commands for a device so that the building material is solidified such that the envelop region encloses the object in at least a section thereof and the positions that correspond to the envelop region are solidified less strongly than the positions that correspond to the three-dimensional object. The device comprises an application device that can be moved over a build area for applying a layer of the building material to the build area and a solidification device for selectively solidifying the applied layer at positions that correspond to a cross-section of the object to be produced and of an envelop region and which device is configured and/or controlled to repeat the steps of applying and selectively solidifying until the object and the envelop region are completed. This makes it possible to generate control commands which can be executed in order to carry out the method according to the invention.

A control unit according to the invention is provided for a device for producing a three-dimensional object by layer-wise applying and selectively solidifying a building material, wherein the device comprises: an application device that can be moved over a build area for applying a layer of the building material to the build area and a solidification device for selectively solidifying the applied layer at positions that correspond to the cross-section of the object to be produced and of an envelop region. The device is configured and/or controlled to repeat the steps of applying and selectively solidifying until the object and the envelop region are completed. The control unit is configured to control the device so that the building material is solidified such that the envelop region encloses the object in at least a section thereof and the positions that correspond to the envelop region are solidified less strongly than the positions that correspond to the three-dimensional object. This makes it possible to carry out the method according to the invention by means of the control unit.

According to the invention, a device for producing a three-dimensional object by layer-wise applying and selectively solidifying a building material comprises an application device that can be moved over a build area for applying a layer of the building material to the build area and a solidification device for selectively solidifying the applied layer at positions that correspond to the cross-section of the object to be produced and of an envelop region. The device is configured and/or controlled to repeat the steps of applying and selectively solidifying until the object and the envelop region are completed, to solidify the building material such that the envelop region encloses the object in at least a section thereof and to solidify those positions that correspond to the envelop region such that the positions that correspond to the envelop region are solidified less strongly than those positions that correspond to the three-dimensional object. This makes it possible to carry out the method according to the invention by means of the device for producing a three-dimensional object.

Further features and expediencies of the invention are set out in the description of exemplary embodiments with the aid of the attached drawings.

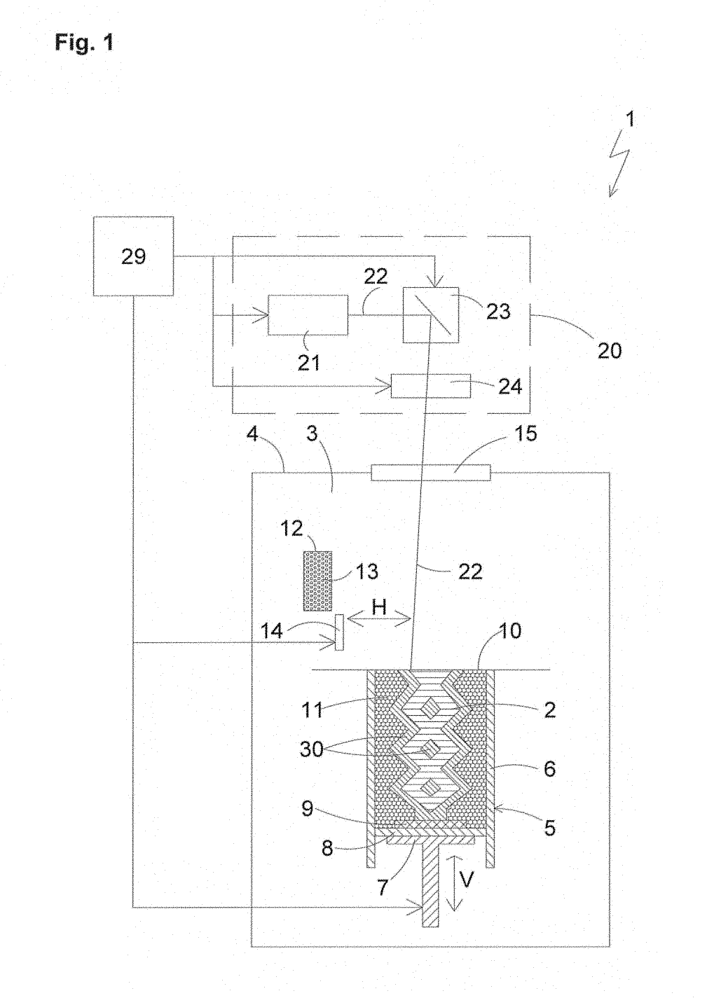

FIG. 1 shows a schematic view, partially in cross-section, of an exemplary embodiment of a device for producing a three-dimensional object layer by layer, which device is configured to implement a method according to the invention.

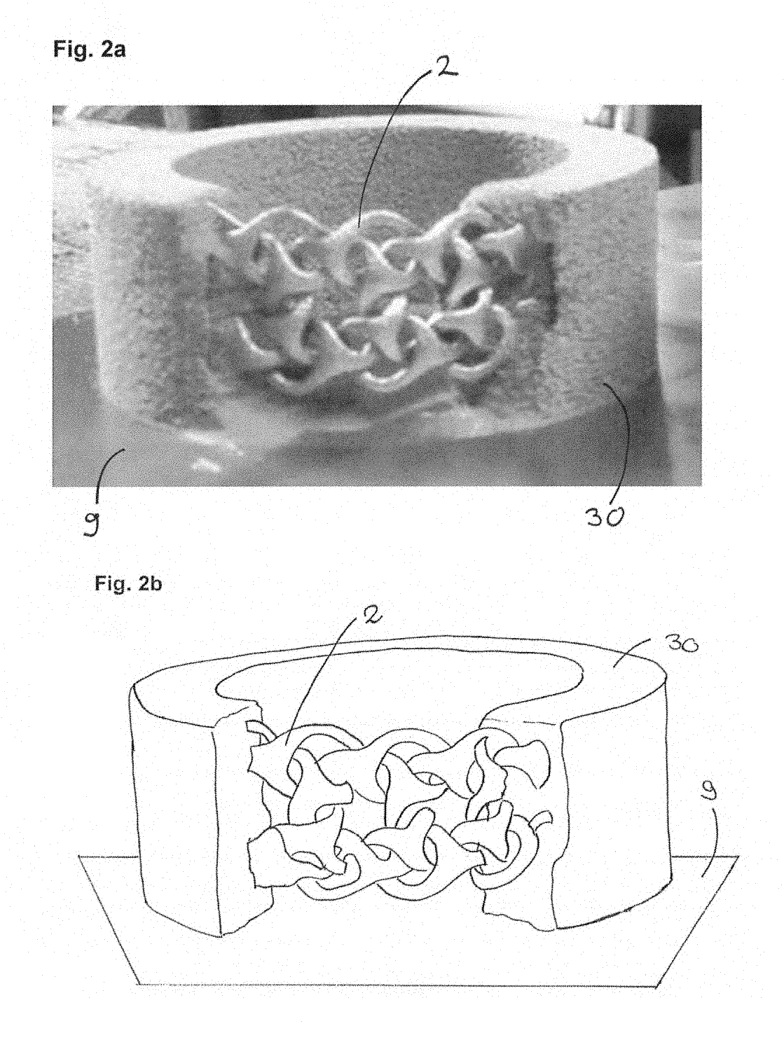

FIG. 2a shows a perspective view of a three-dimensional object with an (already partially removed) envelop region and FIG. 2b schematically shows a perspective view of the object shown in FIG. 2a.

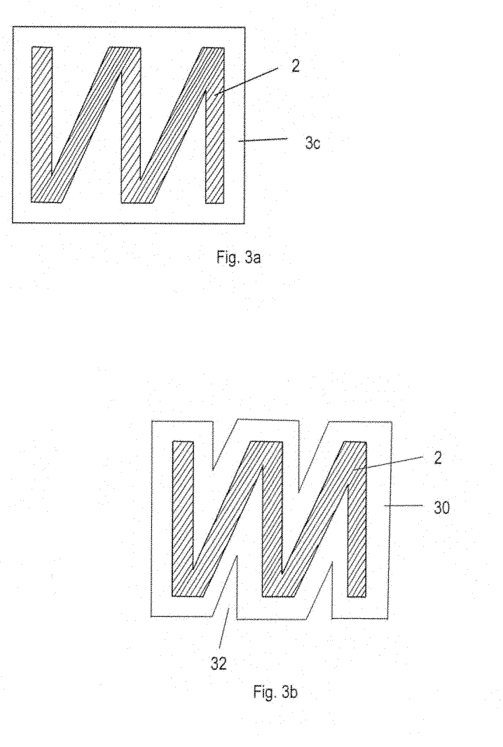

FIG. 3a-FIG. 3b schematically show views in cross-section of exemplary embodiments of a three-dimensional object with an envelop region according to a method according to the invention.

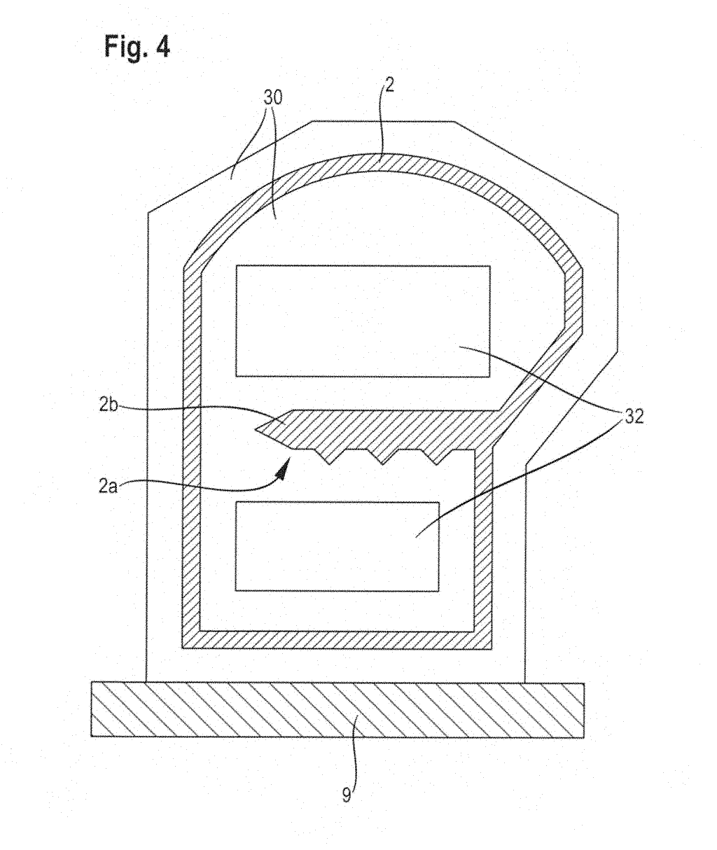

FIG. 4 shows a schematic view in cross-section of a three-dimensional object with an envelop region according to a first embodiment of the method according to the invention.

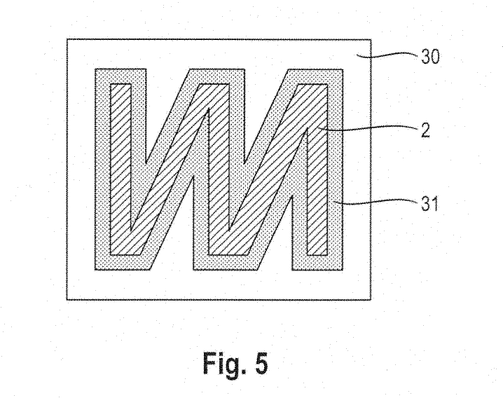

FIG. 5 shows a schematic view in cross-section of a three-dimensional object with an envelop region according to a second embodiment of the method according to the invention.

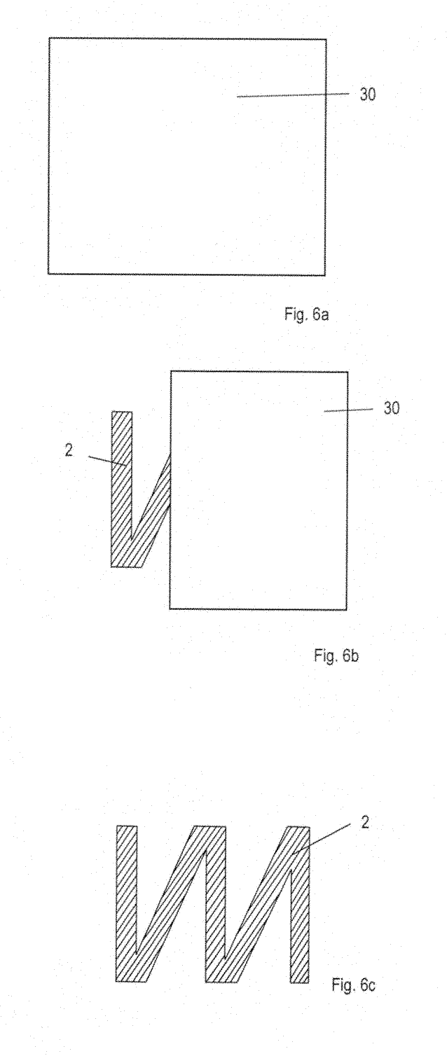

FIG. 6a-FIG. 6c show schematic views in cross-section of a three-dimensional object with an envelop region that depict removing of the envelop region according to a method according to the invention.

Hereafter, an exemplary embodiment of a device 1 is described with reference to FIG. 1, which device 1 is suited to implement a method according to the invention. The device shown in FIG. 1 is a laser sintering or laser melting device 1. For building an object 2 having an envelop region 30, it comprises a processing chamber 3 with a chamber wall 4.

A container 5 open to the top with a wall 6 is arranged in the processing chamber 3. In the container 5 a support 7 is arranged that can be moved in a vertical direction V and to which a base plate 8 is attached which seals the container 5 at the bottom and thus forms the bottom thereof. The base plate 8 can be formed as a plate separately from the support 7 which plate is fixed to the support 7, or it can be integrally formed with the support 7. Depending on the powder and process used, a building platform 9 can also be arranged on the base plate 8 on which the object 2 and the envelop region 30 are built. However, the object 2 and the envelop region 30 can also be built on the base plate 8 itself, which then serves as a building platform. In FIG. 1, the object 2 to be formed in the container 5 on the building platform 9 is shown below a working plane 10 in an intermediate state with several solidified layers, surrounded by the envelop region 30 and building material 11 that remained unsolidified.

The laser sintering device 1 further comprises a storage container 12 for a building material in powder form 13 which can be solidified by electromagnetic radiation and an application device 14 that can be moved in a horizontal direction H for applying the building material 13 to the working plane 10. On its upper side, the wall 4 of the processing chamber 3 comprises a coupling window 15 for the radiation 22 which radiation serves for solidifying the building material 13.

The laser sintering device 1 further comprises an irradiation device 20 with a laser 21 which produces a laser beam 22 which is deflected by a deflection device 23 and focused upon the working plane 10 by way of a focusing device 24 through the coupling window 15.

Furthermore, the laser sintering device 1 comprises a control unit 29 by which the individual components of the device 1 can be controlled in a coordinated manner in order to implement the building process. The control unit can comprise a CPU, the operation of which is controlled by a computer program (software). The computer program can be stored separately from the device on a storage medium from which it can be loaded into the device, in particular into the control unit 29. In particular, the control unit 29 can generate control commands for the device 1 and control the device 1 by outputting the control commands to the device 1.

In operation, in order to apply a layer of the building material 13, the support 7 is first lowered by an amount that corresponds to the desired layer thickness. Then, a layer of the building material 13 is applied using the application device 14. Application takes place at least over the entire cross-section of the object 2 to be produced, preferably over the entire build area, i.e. the part of the working plane 10 located within the opening of the container 5. Then, the cross-section of the object 2 to be produced is scanned by the laser beam 22 so that the building material 13 is solidified at those positions that correspond to the cross-section of the object 2 to be produced. These steps are repeated until the object 2 is completed and can be removed from the building space.

In order to support the object 2 within the unsolidified building material 11 during its production process, according to the present invention, an envelop region 30 is built around the object 2. FIG. 2a shows a completed three-dimensional object 2 with an envelop region 30, which envelop region has already been partially removed, on a building platform 9 and FIG. 2b schematically shows a view of the object shown in FIG. 2a with the envelop region 30. As shown, the object 2 is a ring having a radius R, which has filigree structures. The envelop region 30 is designed as a hollow cylinder with an outer radius ri and an inner radius r₂, wherein: r₂<R<r₁, so that the ring is completely enclosed by the hollow cylinder. As a result, the filigree structures of the ring are well supported by the envelop region 30 during the production process.

During the production process, those positions that correspond to the envelop region 30 are solidified less strongly than those positions that correspond to the object 2. This is achieved by introducing less energy at positions that correspond to the envelop region in a layer than at positions that correspond to the object. For this purpose, for example, the laser power can be reduced and/or the distance between adjacent laser scan lines (hatch distance) can be increased and/or the velocity with which the laser beam 22 is moved over the working plane 10 can be increased. In the table below, exemplary values are respectively given for the exposure parameters laser power, hatch distance and velocity for the solidification of the building material 13 at positions corresponding to the object 2 and to the envelop region 30, which exemplary values result in a less strong solidification of the envelop region 30.

| | Laser | Hatch | |
|---|---|---|---|
| | Power | Distance | Velocity |
| Object | 170 W | 0.10 mm | 1250 mm/s |
| Envelop region | 90 W | 0.20 mm | 2250 mm/s |

The values given in the table are only examples, different values can also be chosen. Also, only one or two of the given parameters for the solidification of the building material 13 at positions corresponding to the envelop region 30 can deviate from those parameters chosen for solidifying the building material 13 at positions corresponding to the object 2.

To compute the layer information, the geometry of the object 2 to be produced is first computed and the data thus obtained is stored. Then, the geometry of a contrived body is computed, which body completely encloses the object 2. Subsequently, the geometry of the object 2 is subtracted from the geometry of the body and the body thus obtained is stored as the geometry of the envelop region 30. For generating the layer information, the cross-section of the three-dimensional object 2 and of the envelop region 30 are computed in the respective layers and the data thus obtained is stored.

The contrived body that serves to generate the layer information of the envelop region 30 is computed in such a way that the body has a volume as small as possible. A volume of the body that is as small as possible is chosen by taking into account that the envelop region 30 must provide a sufficiently large support function for the object 2, which is no longer the case with a body that is too small. This can be ensured, for example, by selecting a minimum wall thickness of the envelop region depending on a wall thickness or thickness of the object 2.

FIG. 3a shows a view of an object 2 and an envelop region 30 in cross-section. The envelop region 30 is computed from a body which was not chosen from the viewpoint of a volume as small as possible. FIG. 3b shows an envelop region 30 that has been computed from a body having a volume as small as possible. In this case, the wall thickness of the envelop region is approximately constant and the envelop region has interspaces 32 which are filled with building material 11 that remained unsolidified.

By choosing a volume of the envelop region 30 that is as small as possible, building material 13 can be saved, which renders the production of a three-dimensional object 2 having an envelop region 30 more cost-effective. Furthermore, by doing so, the time for production is reduced because less material is solidified and less material must be removed in order to remove the envelop region 30.

Thus, it is also possible to fill cavities locate in the interior of the object 2 with the envelop region 30. FIG. 4 shows a three-dimensional object 2 having a cavity 2a that is located inside the object 2. The structure 2b located in the cavity 2a is also supported by the envelop region 30. Thus, the three-dimensional object 2 is completely enclosed by the envelop region 30. The term “completely enclosed” means that the envelop region 30 surrounds all surfaces (also inner surfaces) of the object 2. In doing so, the envelop region 30 can also have interspaces 32 which can be filled with building material 11 that remained unsolidified. Thus, the envelop region 30 does not need to fill a cavity 2a of the object 2 completely.

The envelop region 30 encloses the object 2 substantially in a form-fitting manner, i.e. the surface of the envelop region 30 that faces the object is formed complementary to the surface of the object 2. A contact between a surface of the object 2 and the envelop region 30 is not necessarily required.

In FIG. 4, the envelop region 30 is provided on the building platform 9. This ensures a good connection of the object 2 to the building platform 9. Alternatively, the envelop region 30 can also be provided detached from the building platform 9, or no envelop region 30 can be provided between the object 2 and the building platform 9 so that the object 2 is built directly on the building platform 9.

FIG. 5 shows a view of a three-dimensional object 2 in cross-section, which object 2 is completely enclosed by an envelop region 30. Between the object 2 and the envelop region 30, a gap 31 is provided, so that the envelop region 30 is solidified at a distance from the three-dimensional object 2. The width of the gap 31 and thus the distance of the envelop region 30 from the object 2 is preferably approximately constant and/or larger than or equal to 0.06 mm and less than or equal to 0.10 mm. This prevents building material 13 that belongs to the envelop region 30 from adhering to or merging with the surface of the object 2 during the building process. This eliminates complex post-processing of the surface of the object. 2 The gap 31 can be filled with building material 11 that remained unsolidified, thus ensuring a sufficient supporting effect.

FIG. 6a-FIG. 6c depict the steps of a method according to the invention for removing the envelop region 30 after completion of the object 2. FIG. 6a shows an envelop region 30 that completely encloses the object 2 so that the object is not visible to the observer. According to the invention, the envelop region 30 is removed from the object by blasting. Since the building material 13 is solidified less strongly at those positions that correspond to the envelop region 30 than at those positions that correspond to the object 2, it is thus possible to remove the envelop region 30 by means of blasting without damaging the object 2. Hard particles are used as blasting medium, such as ceramic particles or steel balls. Particles having a diameter of 0.3-0.6 mm are well suited, however, other suitable particle sizes are also conceivable. The pressure of the particle beam is preferably 4-6 bar, however, the method can also be carried out with different pressures.

FIG. 6b shows the object 2 and the envelop region 30 in an intermediate state in which the object 2 is partially enclosed by the envelop region and partially exposed. The left part of the object 2 is already exposed, the right part of the object 2 is still enclosed by the envelop region 30. FIG. 6c shows the object 2 after complete removal of the envelop region 30.

In the exemplary embodiments described, the object is completely enclosed by the envelop region, so that the envelop region surrounds all surfaces (including inner surfaces) of the object. However, the envelop region can also be solidified such that it encloses the object only in sections, so that not all surfaces of the object are surrounded by the envelop region. For example, the envelop region 30 shown in FIG. 4 can be formed only around horizontal structures of the object 2 and vertical structures of the object 2 may be omitted from the envelop region 30. Alternatively, it is also possible to solidify the envelop region 30 only in the inner cavity 2a of the object 2. Thus, the inner horizontal structure 2b is supported as well as the horizontal upper face of the object 2.

The gap described with respect to FIG. 5, which gap is provided between the three-dimensional object and the envelop region, does not necessarily have to be provided around the entire surface of the object 2. Rather, it is also possible to arrange the gap only in one spatial direction, for example in the vertical or horizontal direction, or in two spatial directions around the object. The gap can also be solidified only partially in one or more spatial directions around the object.

The envelop region does not necessarily have to be removed from the object by means of blasting. It is also possible to remove the envelop region by means of another known method, such as by a force introduced manually or mechanically, such as hammering, rubbing (rasping, etc.).

Even though the present invention was described with regard to a laser sintering or laser melting device, it is not limited to laser sintering or laser melting. It can be applied to any methods for producing a three-dimensional object by layer-wise applying and selectively solidifying a building material.

The laser can comprise, for example, a gas or solid state laser or any other kind of laser. In general, any device may be used as an irradiation device with which energy can be applied selectively to a layer of building material. Instead of a laser, for example, a different light source, an electron beam or any other source of energy or radiation can be used which is suited for solidifying the building material. The invention can also be applied to selective mask sintering, in which an extended light source and are mask are used, or the invention can be applied to absorption or inhibition sintering.

Instead of introducing energy, the building material applied can also be selectively solidified by 3D printing, for example by applying an adhesive. In general, the invention is directed to the production of an object by means of layer-wise applying and selectively solidifying a building material, regardless of the manner in which the building material is solidified.

Various materials can be used as a building material, in particular materials in powder form such as metal powders, plastic powders, ceramic powders, sand, filled or mixed powders. Since supporting the object to be produced is particularly important in the case of metallic building materials, a particularly good effect can be achieved by the envelop region when a metal powder is used as building material.

1. A method for producing a three-dimensional object by layer-wise applying and selectively solidifying a building material, the method comprising the steps of:
applying a layer of the building material to a build area by means of an application device,
selectively solidifying the applied layer at positions that correspond to the cross-section of the object in the respective layer and at positions that correspond to the cross-section of an envelop region
and repeating the steps of applying and selectively solidifying until the object and the envelop region are completed,
wherein the building material is solidified such that the envelop region encloses the object in at least a section thereof,
wherein the positions that correspond to the envelop region are solidified less strongly than the positions that correspond to the three-dimensional object.

2. The method of claim 1, wherein the envelop region completely encloses the three-dimensional object in at least two spatial directions.

3. The method of claim 1, wherein the envelop region encloses the object or the part of the object substantially in a form-fitting manner.

4. The method of claims 1, with the additional step of:
removing the envelop region after completion of the object, by means of blasting, wherein at least one of ceramic particles and steel balls are used as a blasting medium when blasting.

5. The method of claims 1, wherein the solidification of the building material is implemented by introducing energy by means of radiation and wherein less energy is introduced at the positions that correspond to the envelop region than at the object.

6. The method of claims 1, wherein the envelop region is at least partially solidified at a distance from the three-dimensional object.

7. The method of claim 6, wherein the distance between the envelop region and the object is larger than or equal to 0.06 mm and smaller than or equal to 0.10 mm.

8. The method of claim 6, wherein the distance between envelop region and object is constant.

9. The method of claims 1, wherein the building material is a metal powder.

10. The method of claims 1, wherein the following steps are carried out in advance:
computing the geometry of the three-dimensional object,
computing the geometry of a body which encloses the object in at least a section thereof,
subtracting the geometry of the object from the geometry of the body,
saving the generated geometry as the geometry of the envelop region, and
computing the cross-section of the object and the cross-section of the envelop region in the respective layers.

11. The method of claim 10, wherein the geometry of the body is chosen such that the body has a volume as small as possible or that the body completely encloses the three-dimensional object.

12. A computer program being loadable into a programmable control unit and having program code means to carry out all steps of a method according to claims 1 when the computer program is executed on the control unit.

13. A control command generating unit for a device for producing a three-dimensional object by layer-wise applying and selectively solidifying a building material, wherein the device comprises:
an application device that can be moved over a build area for applying a layer of the building material to the build area,
a solidification device for selectively solidifying the applied layer at positions that correspond to the cross-section of the object to be produced and of an envelop region,
wherein the device is configured or controlled to:
repeat the steps of applying and selectively solidifying until the object and the envelop region are completed,
wherein the control command generating unit is adapted to generate control commands for the device so that
the building material is solidified such that the envelop region encloses the object in at least a section thereof, and
the positions that correspond to the envelop region are solidified less strongly than the positions that correspond to the three-dimensional object.

14. A control unit for a device for producing a three-dimensional object by layer-wise applying and selectively solidifying a building material, wherein the device comprises:
an application device that can be moved over a build area for applying a layer of the building material to the build area,
a solidification device for selectively solidifying the applied layer at positions that correspond to the cross-section of the object to be produced and of an envelop region,
wherein the device is configured and/or controlled to:
repeat the steps of applying and selectively solidifying until the object and the envelop region are completed,
wherein the control unit is configured to control the device so that
the building material is solidified such that the envelop region encloses the object in at least a section thereof, and
the positions that correspond to the envelop region are solidified less strongly than the positions that correspond to the three-dimensional object.

15. A device for producing a three-dimensional object by layer-wise applying and selectively solidifying a building material, the device comprising:
an application device that can be moved over a build area for applying a layer of the building material to the build area,
a solidification device for selectively solidifying the applied layer at positions that correspond to the cross-section of the object to be produced and of an envelop region,
wherein the device is configured and/or controlled to:
repeat the steps of applying and selectively solidifying until the object and the envelop region are completed,
solidify the building material such that the envelop region encloses the object in at least a section thereof, and
solidify the positions that correspond to the envelop region so that the positions that correspond to the envelop region are solidified less strongly than the positions that correspond to the three-dimensional object.
